(19) United States
(12) Patent Application Publication
(10) Pub. No.: US 2007/0018771 A1
(43) Pub. Date: Jan. 25, 2007

(54) Inductive-system

(75) Inventors: Kui Yong Lim, Singapore (SG); Su Hwei Lee, Singapore (SG)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 10/564,292

(22) PCT Filed: Jun. 28, 2004
(86) PCT No.: PCT/IB04/51021

§ 371 Date: Jan. 10, 2006

(30) Foreign Application Priority Data
Jul. 11, 2003 (EP) 03102113.2

(51) Int. Cl. H01F 27/28

(52) U.S. Cl. 336/232

(57) ABSTRACT

Inductive-systems (1,2) comprising a first part in the form of a printed coil (11,21) and a second part in the form of a non-printed coil (12,22) coupled serially to each other may have a relatively large inductive-value and still be relatively small in size. The nonprinted coil (12,22) comprises an air coil. The total inductance of the inductive-system (1,2) is substantially equal to an inductance of the printed coil (11,21) plus an inductance of the air coil plus a mutual inductance, which depends on an overlapping area between the printed coil (11,21) and the air coil. One end of the non-printed coil (12) is coupled to a center end of the printed coil (11), and the other end of the nonprinted coil (12) and an outer end of the printed coil (11) constitute ends of the inductive-system (1), to couple both coils (11,12) compactly.

The invention relates to an inductive-system, to a printed circuit board comprising an inductive-system, to a tuner comprising a filter with an inductive-system, and to a method for producing an inductive-system.

An example of such an inductive-system is a coil, a chip inductor etc. The tuner for example forms part of a television receiver.

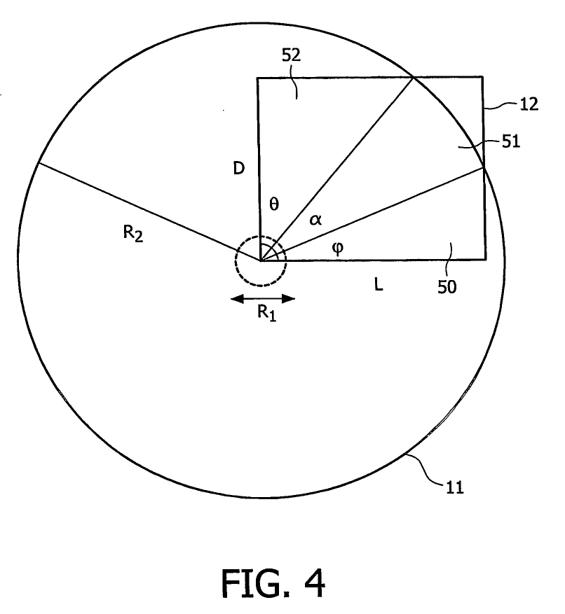

A prior art inductive-system is known from U.S. Pat. No. 6,163,300, which discloses in its FIG. 2 a chip inductor, in its FIG. 6 a helical coil, and in its FIG. 17-19 pattern coils.

In tuners in television receivers, inductive-systems having relatively large inductive-values are required. When realising such a relatively large inductive-value through a helical coil mounted on a printed circuit board, this helical coil gets a relatively large physical size. This leaves less room for the other components on the printed circuit board, or the printed circuit board must be made relatively large in size. When realising such a relatively large inductive-value through a pattern coil printed in the printed circuit board, this pattern coil gets a relatively large physical size. This leaves less room for the other prints in the printed circuit board, or the printed circuit board must be made relatively large in size.

The known inductive-system is disadvantageous, inter alia, due to, for relatively large inductive-values, getting relatively large in size.

It is an object of the invention, inter alia, of providing an inductive-system which, for relatively large inductive-values, is relatively small in size.

Furthers objects of the invention are, inter alia, providing a printed circuit board comprising an inductive-system which, for relatively large inductive-values, is relatively small in size, providing a tuner comprising a filter with an inductive-system which, for relatively large inductive-values, is relatively small in size, and providing a method for producing an inductive-system which, for relatively large inductive-values, is relatively small in size. The inductive-system according to the invention comprises—a first part in the form of a printed coil comprising a number of turns defined by at least one track width and at least one turn spacing; and—a second part in the form of a non-printed coil; which printed coil and which non-printed coil are coupled serially.

By serially coupling the printed coil (like for example a pattern coil etc.) and the non-printed coil (like for example a chip inductor etc.), the inductive-values of both coils are to be added, resulting in the inductive-system getting a relatively large inductive-value. So, both coils are coupled serially for making the inductive-value of the inductive-system larger than each inductive-value of each individual coil. Due to the first part being printed and therefore being located in a printed circuit board and the second part being non-printed and therefore being mounted on the printed circuit board, the inductive-system uses the available room efficiently, and is relatively small in size.

It should be noted that U.S. Pat. No. 6,307,440 B1 discloses an inductive-system with a pattern coil in a printed circuit board and an air-core coil mounted on the printed circuit board. However, these coils are coupled in parallel, to adjust an oscillation frequency of an oscillator circuit by adjusting an angle of the air-core coil relative to the printed circuit board. Both coils each comprise half a turn or more and less than one turn and are therefore not defined by at least one turn spacing, because a turn spacing requires a coil to have more than one turn. So, this inductive-system does not comprise serially coupled coils and is not designed, adapted or arranged for making the inductive-value of the inductive-system larger than an individual inductive-value of an individual coil.

A first embodiment of the inductive-system according to the invention is defined by claim 2. By realising the non-printed coil through an air coil comprising a further number of turns defined by at least one wire diameter and at least one coil diameter, the non-printed coil can be coupled magnetically to a further component and/or to a further part of the printed circuit board.

A second embodiment of the inductive-system according to the invention is defined by claim 3. The total inductance of the inductive-system is substantially equal to an inductance of the printed coil plus an inductance of the air coil plus a mutual inductance. So, the inductive-value of the inductive-system can be made larger than the sum of the inductive-values of both coils, dependently on the sign of the mutual inductance.

A third embodiment of the inductive-system according to the invention is defined by claim 4. The value of the mutual inductance can be chosen by combining a right turn air coil or a left turn air coil with a clockwise printed coil or an anti-clockwise printed coil and by selecting a length of the air coil, and increases with the length of the air coil until a maximum overlapping area between the printed coil and the air coil has been reached.

A fourth embodiment of the inductive-system according to the invention is defined by claim 5. The number of turns are further defined by a diameter of a center path and a turning direction (clockwise or anti-clockwise), with the further number of turns being further defined by a turning orientation (right turn or left turn), to create more design options.

A fifth embodiment of the inductive-system according to the invention is defined by claim 6. With one end of the non-printed coil being coupled to a center end of the printed coil, and with the other end of the non-printed coil and an outer end of the printed coil constituting ends of the inductive-system, both coils are coupled in a compact way.

A sixth embodiment of the inductive-system according to the invention is defined by claim 7. The printed coil can be printed on an inner or an outer layer of a printed circuit board, to create more design options, and with the kind of layer used being of little influence to the functioning of the inductive-system.

The printed coil can be cylindrical, rectangular, hexagonal etc. and the air coil can be cylindrical, rectangular, hexagonal etc. without departing from the scope of this invention. So, the word “turn” may be a kind of circular turn, a kind of rectangular turn, a kind of hexagonal turn etc.

Embodiments of the printed circuit board according to the invention, of the tuner according to the invention and of the method according to the invention correspond with the embodiments of the inductive-system according to the invention.

The invention is based upon an insight, inter alia, that large printed coils and large non-printed coils are to be avoided, and is based upon a basic idea, inter alia, that both kinds of coils can be combined efficiently by coupling them serially.

The invention solves the problem, inter alia, of providing an inductive-system which, for relatively large inductive-values, is relatively small in size, and is advantageous, inter alia, in that the available room is used efficiently.

These and other aspects of the invention will be apparent from and elucidated with reference to the embodiments(s) described hereinafter.

In the drawings:

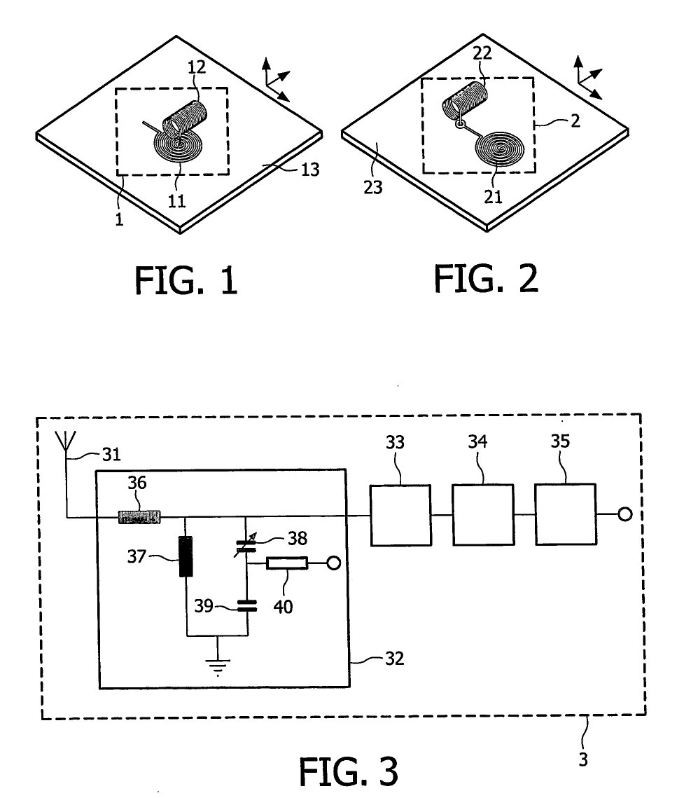

FIG. 1 shows in block diagram form an inductive-system according to the invention;

FIG. 2 shows in block diagram form another inductive-system according to the invention;

FIG. 3 shows in block diagram form a tuner according to the invention; and

FIG. 4 shows in schematical form a top view of a printed coil and an air coil.

The inductive-system 1 according to the invention shown in FIG. 1 comprises a printed coil 11 printed on a printed circuit board 13, and an air coil 12 mounted on the printed circuit board 13. Both coils 11,12 are coupled serially, with one end of the air coil 12 being coupled to a center end of the printed coil 11 and with the other end of the air coil 12 and the outer end of the printed coil 11 forming the ends of the inductive-system 1.

The inductive-system 2 according to the invention shown in FIG. 2 comprises a printed coil 21 printed on a printed circuit board 23, and an air coil 22 mounted on the printed circuit board 23. Both coils 21,22 are coupled serially, with one end of the air coil 22 being coupled to an outer end of the printed coil 21 and with the other end of the air coil 22 and the inner end of the printed coil 21 forming the ends of the inductive-system 2.

The tuner 3 according to the invention shown in FIG. 3 comprises an antenna input 31 to be coupled to an antenna or a cable or a satellite receiver etc. Antenna input 31 is coupled to an input of a filter 32, of which an output is coupled to an input of an amplifier 33, of which an output is coupled to an input of a bandpass filter 34, of which an output is coupled to an input of a mixer 35 etc. Filter 32 comprises a coil 36 coupled between the input and the output of the filter 32. Filter 32 further comprises a coil 37 coupled between the output of filter 32 and ground, and a serial circuit coupled in parallel to coil 37 and comprising a variable capacitor 38 and a capacitor 39. The common point of this serial circuit is coupled via a resistor 40 to a control input for receiving a control voltage for adjusting the variable capacitor 38 for tuning purposes. Each one of coils 36 and 37 may correspond with the inductive-system 1 or 2 as shown in FIG. 1 or 2. Bandpass filter 34 may also comprise an inductive-system 1 or 2.

The top view of a printed coil 11 and an air coil 12 as shown in FIG. 4 comprises the printed coil 11 having a radius (R₂) and the air coil 12 having a coil diameter (D) and a length (L). An overlapping area 50,51,52 comprises a first triangle 50 having a surface area equal to 0.5·L·R₂·sin (φ), a circle segment 51 having a surface area equal to 0.5·(R₂)²·α, and a second triangle 52 having a surface area equal to 0.5·D·R₂·sin (θ).

The printed coil 11 comprises a number (n) of turns defined by at least one track width (w) and at least one turn spacing (s). The air coil 12 comprises a further number (T) of turns defined by at least one wire diameter (W) and at least one coil diameter (D). The number (n) of turns are further defined by a diameter of a center path (R₁) and a turning direction (d being clockwise or counterclockwise), with the further number (T) of turns being further defined by a turning orientation (O being left or right). The diameter of the center path (R₁) corresponds with a diameter of a most inner path, with the radius (R₂) corresponding with half the diameter of a most outer path. A total inductance of the inductive-system 1 is substantially equal to an inductance of the printed coil 11 plus an inductance of the air coil 12 plus a mutual inductance. The value of the mutual inductance is chosen by combining a right turn air coil or a left turn air coil with a clockwise printed coil or an counterclockwise printed coil and by selecting a length (L) of the air coil 12, with the mutual inductance increasing with the length (L) of the air coil 12 until a maximum overlapping area (50,51,52) between the printed coil 11 and the air coil 12 has been reached. The mutual inductance is relatively large negative for right turn air coils 12 combined with clockwise printed coils 11, and for left turn air coils 12 combined with counterclockwise printed coils 11. For other combinations of air coils and printed coils, the mutual inductance is slightly negative for air coils having a relatively low number of turns (T) and increasingly positive for air coils having an increasing number of turns (T). The mutual inductance is relatively independent from the kind of layer (inner layer or outer layer) used for the printed coil 11.

The inductive value of the printed coil 11 should be at most for example 1/3 of the inductive value of the inductive-system 1, to avoid that spreading in printed circuit board factors like etching accuracy and dielectric constant etc. get too much influence. When used in a 100 MHz region, the air coil 12 may have an inductance of about 200 nH and a Quality factor Q of about 100, the printed coil 11 may have an inductance of about 150 nH and a Quality factor Q of about 65, with the inductive-system having an inductance of about 350 nH and a Quality factor Q of about 84.

The printed coil 11,21 can be cylindrical, rectangular, hexagonal etc. and

the air coil 12,22 can be cylindrical, rectangular, hexagonal etc. without departing from the scope of this invention. So, the word “turn” may be a kind of circular turn, a kind of rectangular turn, a kind of hexagonal turn etc.

The expression “for” in for example “for A” and “for B” does not exclude that other functions “for C” are performed as well, simultaneously or not. The expressions “X coupled to Y” and “a coupling between X and Y” and “coupling/couples X and Y” etc. do not exclude that an element Z is in between X and Y. The expressions “P comprises Q” and “P comprising Q” etc. do not exclude that an element R is comprised/included as well.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “to comprise” and its conjugations does not exclude the presence of elements or steps other than those stated in a claim. The article “a” or “an” preceding an element does not exclude the presence of a plurality of such elements. The mere fact that certain measures are recited in mutually different dependent claims does not indicate that a combination of these measures cannot be used to advantage.

The invention is based upon an insight, inter alia, that large printed coils and large non-printed coils are to be avoided, and is based upon a basic idea, inter alia, that both kinds of coils can be combined efficiently by coupling them serially.

The invention solves the problem, inter alia, of providing an inductive-system which, for relatively large inductive-values, is relatively small in size, and is advantageous, inter alia, in that the available room is used efficiently.

1. Inductive-system (1,2) comprising—a first part in the form of a printed coil (11,21) comprising a number of turns defined by at least one track width and at least one turn spacing; and—a second part in the form of a non-printed coil (12,22); which printed coil (11,21) and which non-printed coil (12,22) are coupled serially.

2. Inductive-system (1,2) as defined in claim 1, wherein the non-printed coil (12,22) comprises an air coil comprising a further number of turns defined by at least one wire diameter and at least one coil diameter (D).

3. Inductive-system (1,2) as defined in claim 2, wherein a total inductance of the inductive-system (1,2) is substantially equal to an inductance of the printed coil (11,21) plus an inductance of the air coil plus a mutual inductance.

4. Inductive-system (1,2) as defined in claim 3, wherein a value of the mutual inductance has been chosen by combining a right turn air coil or a left turn air coil with a clockwise printed coil or an anti-clockwise printed coil and by selecting a length (L) of the air coil, with the mutual inductance increasing with the length (L) of the air coil until a maximum overlapping area (50,51,52) between the printed coil (11,21) and the air coil has been reached.

5. Inductive-system (1,2) as defined in claim 2, wherein the number of turns are further defined by a diameter of a center path (R₁) and a turning direction, with the further number of turns being further defined by a turning orientation.

6. Inductive-system (1) as defined in claim 1, wherein one end of the non-printed coil (12) is coupled to a center end of the printed coil (11), with the other end of the non-printed coil (12) and an outer end of the printed coil (11) constituting ends of the inductive-system (1).

7. Inductive-system (1,2) as defined in claim 1, wherein the printed coil (11,21) is printed on an inner or an outer layer of a printed circuit board (13,23).

8. Printed circuit board (13,23) which comprises an inductive-system (1,2) comprising—a first part in the form of a printed coil (11,21) comprising a number of turns defined by at least one track width and at least one turn spacing; and—a second part in the form of a non-printed coil (12,22); which printed coil (11,21) and which non-printed coil (12,22) are coupled serially, and which printed coil (11,21) is printed on an inner or outer layer of the printed circuit board (13,23).

9. Tuner (3) which comprises a filter (32) with an inductive-system (1,2) comprising—a first part in the form of a printed coil (11,21) comprising a number of turns defined by at least one track width and at least one turn spacing; and—a second part in the form of a non-printed coil (12,22); which printed coil (11,21) and which non-printed coil (12,22) are coupled serially.

10. Method for producing an inductive-system (1,2) and comprising the steps of—producing a first part in the form of a printed coil (11,21) comprising a number of turns defined by at least one track width and at least one turn spacing;—producing a second part in the form of a non-printed coil (12,22); and—coupling the printed coil (11,21) and the non-printed coil (12,22) serially.
